(19) United States
(12) Patent Application Publication
(10) Pub. No.: US 2019/0389143 A1
(43) Pub. Date: Dec. 26, 2019

(54) INTAKE DUCT FOR INTERNAL COMBUSTION ENGINE

(71) Applicant: TOYOTA BOSHOKU KABUSHIKI KAISHA, Aichi-ken (JP)

(72) Inventors: Ryusuke KIMURA, Ichinomiya-shi (JP); Tomoyo OHNO, Nagoya-shi (JP)

(73) Assignee: TOYOTA BOSHOKU KABUSHIKI KAISHA, Aichi-ken (JP)

(21) Appl. No.: 16/449,792

(22) Filed: Jun. 24, 2019

(30) Foreign Application Priority Data
Jun. 26, 2018 (JP) 2018-121201

(51) Int. Cl. B29C 65/08; F02M 35/10; B29C 65/78

(52) U.S. Cl. CPC B29C 65/08; B29C 65/7808; F02M 35/10091

(57) ABSTRACT

An intake duct for an internal combustion engine includes a tubular wall configuring an intake passage. The wall includes segments that are separate from each other in a circumferential direction of the wall. At least one of the segments is made of a compression-molded fibrous body. Each of the segments includes a flange protruding radially outwards from the wall and having a joint. The joint of the flange of each of the segments and the joint of the flange of the corresponding one of the segments are joined to each other. Each of the flanges includes an opposing surface opposed to the corresponding one of the flanges. The opposing surface is provided with a step portion that is located closer to a proximal side of the flange than to the joint and forms a step in a thickness direction of the flange.

### BACKGROUND

### 1. Field

The following description relates to an intake duct for an internal combustion engine.

### 2. Description of Related Art

An intake passage of an onboard internal combustion engine is provided with an intake duct (refer to, for example, Japanese Laid-Open Patent Publication No. 2007-321600). In this document, the wall of the intake duct is configured by two fibrous molded tubular halved bodies. The opposite ends of each halved body in the circumferential direction are provided with two flanges protruding radially outwards. The flanges, which are in contact with each other in the two halved bodies, are joined to each other through adhering or welding.

When the intake duct of the above-described document is formed through adhering or welding, adhesive or molten plastic may leak from the flanges to the inner side of the wall. This forms burrs on the inner surface of the wall, thereby increasing the airflow resistance.

### SUMMARY

It is an objective of the following disclosure to provide an intake duct for an internal combustion engine that limits an increase in airflow resistance.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An intake duct for an internal combustion engine according to the following description includes a tubular wall configuring an intake passage. The wall includes segments that are separate from each other in a circumferential direction of the wall. At least one of the segments is a compression-molded fibrous body. Each of the segments includes a flange protruding radially outwards from the wall and having a joint, the joint of the flange of each of the segments and the joint of the flange of the corresponding one of the segments being joined to each other. Each of the flanges includes an opposing surface opposed to the corresponding one of the flanges, the opposing surface being provided with a step portion that is located closer to a proximal side of the flange than to the joint and forms a step in a thickness direction of the flange.

Other features and aspects will be apparent from the following detailed description, the drawings, and the claims.

### BRIEF DESCRIPTION OF THE DRAWINGS

FIG. 1 is a perspective view showing an intake duct for an internal combustion engine according to the present embodiment.

FIG. 2 is a cross-sectional view taken along line 2-2 in FIG. 1.

FIG. 3 is a cross-sectional view of the flanges shown in FIG. 1.

FIG. 4 is a cross-sectional view of an intake duct according to a first modification, corresponding to FIG. 3.

FIG. 5 is a cross-sectional view of an intake duct according to a second modification, corresponding to FIG. 3.

FIG. 6 is a cross-sectional view of an intake duct according to a third modification, corresponding to FIG. 3.

FIG. 7 is a cross-sectional view of an intake duct according to a fourth modification, corresponding to FIG. 3.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

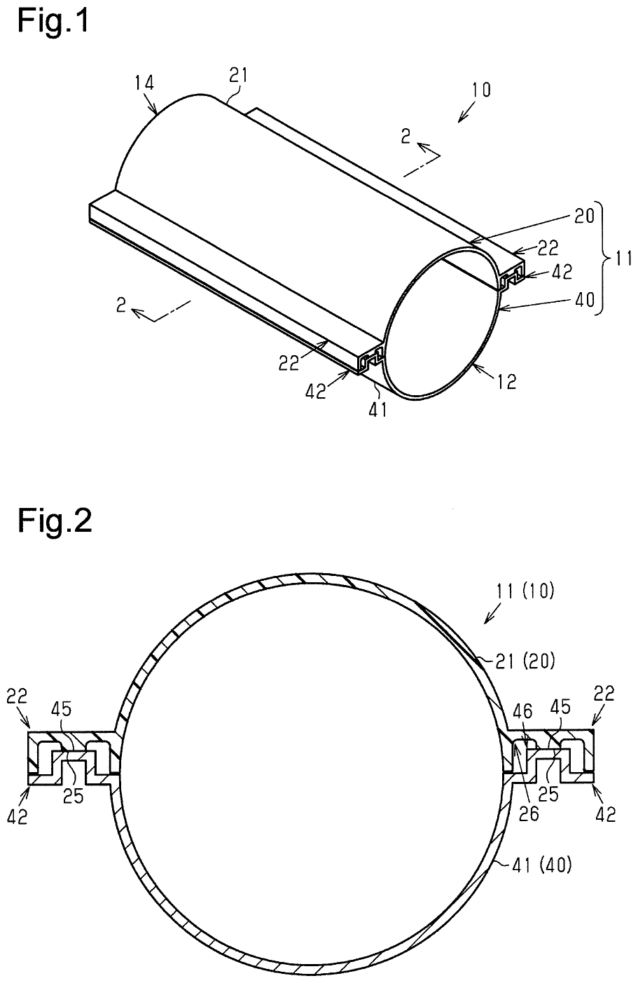

An intake duct for an internal combustion engine (hereinafter referred to as intake duct 10) according to an embodiment will now be described with reference to FIGS. 1 and 2. In the following description, the upstream side and the downstream side in the flow direction of intake air in the intake duct 10 are simply referred to as an upstream side and a downstream side, respectively.

As shown in FIG. 1, the intake duct 10 includes a tubular wall 11. The upstream end of the wall 11 is provided with an inlet 12 into which intake air is drawn. The downstream end of the wall 11 is provided with a connection port 14 connected to, for example, an air cleaner.

The wall 11 is split into two parts in the circumferential direction. The two parts are two segments (first segment 20 and second segment 40), which have the form of a halved tube.

Referring to FIG. 2, the first segment 20 is a hard plastic formed body and includes a first wall 21 and two first flanges 22. The first wall 21 has the form of a halved tube. The first flanges 22 respectively protrude radially outwards from the outer surfaces of the opposite ends of the first wall 21 in the circumferential direction. The first flanges 22 are arranged entirely in the axial direction of the first wall 21 (refer to FIG. 1).

The second segment 40 is a compression-molded fibrous body and includes a second wall 41 and two second flanges 42. The second wall 41 has the form of a halved tube. The second flanges 42 respectively protrude radially outwards from the opposite ends of the second wall 41 in the circumferential direction. The second flanges 42 are arranged entirely in the axial direction of the second wall 41 (refer to FIG. 1).

The first wall 21 and the second wall 41 configure the wall 11.

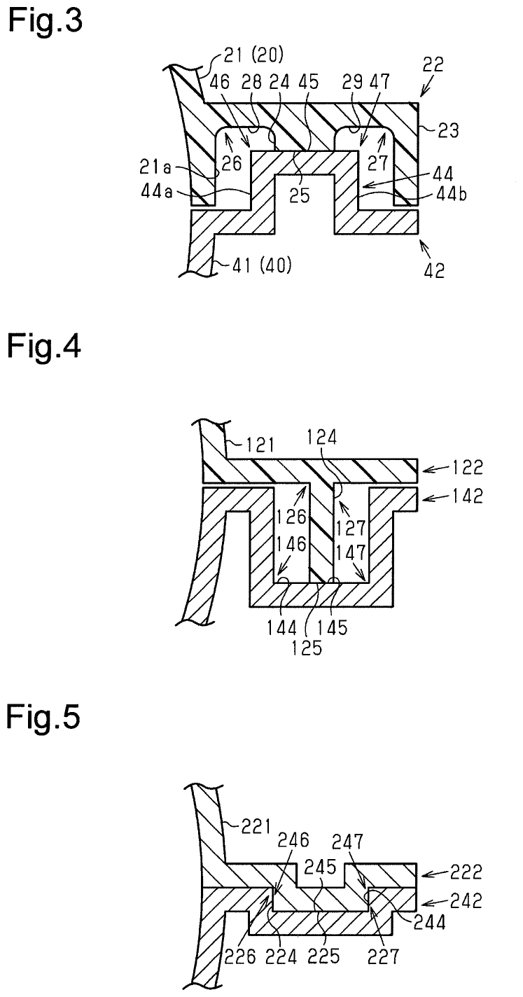

In the following description, the axial direction, the circumferential direction, and the radial direction of the wall 11 are simply referred to as the axial direction, the circumferential direction, and the radial direction, respectively. The protruding direction of the flanges 22 and 42 from the walls 21 and 41 (sideward direction in FIGS. 2 and 3) are referred to as the width direction. The proximal side and the distal side of each of the flanges 22 and 42 in the protruding direction are simply referred to as a proximal side and a distal side, respectively.

The structures of each first flange 22 and each second flange 42 will now be described in detail.

First Flange 22

As shown in FIG. 3, the first flange 22 protrudes radially outwards from the outer surface of the first wall 21. The distal end of the first flange 22 is provided with an outer wall 23 protruding toward the second flange 42. The middle part of the first flange 22 in the width direction is provided with a protrusion 24 protruding toward the second flange 42. The outer wall 23 and the protrusion 24 are arranged entirely in the axial direction. The first wall 21 has an end 21a opposed to the outer wall 23 in the radial direction.

The first flange 22 has an opposing surface opposed to the second flange 42. The opposing surface of the first flange 22 is provided with an inner recess 28 and an outer recess 29. The inner recess 28 is located closer to the proximal side than to the protrusion 24. The outer recess 29 is located closer to the distal side than to the protrusion 24.

The inner recess 28 and the outer recess 29 are arranged entirely in the axial direction.

On the opposing surface of the first flange 22, an inner step portion 26 is formed by the inner recess 28 and the end 21a of the first wall 21. The inner step portion 26 forms a step in the thickness direction of the first flange 22.

On the opposing surface of the first flange 22, an outer step portion 27 is formed by the outer recess 29 and the outer wall 23. The outer step portion 27 forms a step in the thickness direction of the first flange 22.

The inner step portion 26 and the outer step portion 27 are arranged entirely in the axial direction.

Second Flange 42

As shown in FIG. 3, the second flange 42 protrudes radially outwards from the end of the second wall 41.

The middle part of the second flange 42 in the width direction is provided with a protrusion 44 protruding toward the first flange 22. The protrusion 44 is arranged entirely in the axial direction. The second flange 42 has a shape formed by bending a nonwoven fabric sheet, which will be described later.

The middle part of the protrusion 44 in the width direction is provided with a joint 45 joined to a joint 25 of the first flange 22. The joints 25 and 45 are arranged entirely in the axial direction.

The second flange 42 has an opposing surface opposed to the first flange 22. The opposing surface of the second flange 42 is provided with an inner step portion 46 and an outer step portion 47. The inner step portion 46 and the outer step portion 47 each form a step in the thickness direction of the second flange 42. The inner step portion 46 is configured by the protrusion 44 and a part of the second flange 42 located closer to the proximal side than to the protrusion 44. The outer step portion 47 is configured by the protrusion 44 and a part of the second flange 42 located closer to the distal side than to the protrusion 44.

The inner step portion 46 and the outer step portion 47 are arranged entirely in the axial direction.

The protrusion 44 includes an inner wall 44a. A gap is provided between the inner wall 44a and the end surface of the end 21a of the first wall 21. Further, the protrusion 44 includes an outer wall 44b. A gap is provided between the outer wall 44b and the inner surface of the outer wall 23 of the first wall 21.

The joint 25 of the first flange 22 and the joint 45 of the second flange 42 are joined to each other through vibration welding.

The fibrous molded body configuring the second segment 40 will now be described.

The fibrous molded body is made of nonwoven fabric of a PET fiber and nonwoven fabric of core-sheath composite fibers each including, for example, a core (not shown) made of polyethylene terephthalate (PET) and a sheath (not shown) made of denatured PET having a lower melting point than the PET fiber. The denatured PET, which serves as the sheath of the composite fibers, is used as a binder for binding the fibers to each other.

The mixture percentage of denatured PET may be 30 to 70%. For example, in the present embodiment, the mixture percentage of denatured PET is 50%.

Such a composite fiber may also include polypropylene (PP) having a lower melting point than PET.

The mass per unit area of the fibrous molded body may be 500 to 1500 g/m². For example, in the present embodiment, the mass per unit area of the fibrous molded body is 800 g/m².

The second segment 40 is formed by thermally compressing (thermally pressing) the above-described nonwoven sheet having a thickness of, for example, 30 to 100 mm. Further, in the present embodiment, the second wall 41 and the second flange 42 have a thickness of 1.0 mm.

The advantages of the present embodiment will now be described.

(1) The intake duct 10 includes the wall 11, which configures the intake passage and has a tubular shape. The wall 11 includes the first segment 20 and the second segment 40, which are separate from each other in the circumferential direction of the wall 11. The second segment 40 is compression-molded fibrous body. The first segment 20 includes the first flanges 22, which respectively protrude radially outwards from the wall 11 and include the joints 25. The second segment 40 includes the second flanges 42, which respectively protrude radially outwards from the wall 11 and include the joints 45. The joints 25 of the first flanges 22 of the first segment 20 and the joints 45 of the second flanges 42 of the second segment 40 are joined to each other. Each first flange 22 has the opposing surface, which is opposed to the corresponding second flange 42. The opposing surface of the first flange 22 has the inner step portion 26, which is located closer to the proximal side than to the joint 25 and forms a step in the thickness direction of the first flange 22. Each second flange 42 has the opposing surface, which is opposed to the corresponding first flange 22. The opposing surface of the second flange 42 has the inner step portion 46, which is located closer to the proximal side than to the joint 45 and forms a step in the thickness direction of the second flange 42.

In such a structure, adhesive applied to join the flanges 22 and 42 to each other or molten plastic produced by welding the flanges 22 and 42 to each other is prevented from moving toward the positions located closer to the proximal sides of the flanges 22 and 42 than to the joints 25 and 45 by the inner step portions 26 and 46, which serve as obstacles. This limits the leakage of adhesive or molten plastic toward the inner side of the wall 11 through the gaps between the flanges 22 and 42 and limits the production of burrs on the inner surfaces of the wall 11. This limits an increase in the airflow resistance.

Further, the second segment 40 is a compression-molded fibrous body. This facilitates the arrangement of the inner step portion 46 on the second flange 42.

(2) The inner recess 28 is arranged between the joint 25 and the inner step portion 26 of the flange 22 of the flanges 22 and 42, which are opposed to each other.

In such a structure, when adhesive applied to join the flanges 22 and 42 to each other or molten plastic produced by welding the flanges 22 and 42 to each other is moving toward the positions located closer to the proximal sides of the flanges 22 and 42 than to the joints 25 and 45, the adhesive or the molten plastic is accumulated in the inner recess 28. This prevents adhesive or molten plastic from moving toward the proximal sides of the flanges 22 and 42 than to the inner recess 28 and further limits the leakage of adhesive or molten plastic to the inner side of the wall 11 through the gaps between the flanges 22 and 42.

(3) The opposing surfaces of the flanges 22 and 42 are respectively provided with the outer step portions 27 and 47, which are located closer to the distal sides of the flanges 22 and 42 than to the joints 25 and 45 and form steps in the thickness direction of the flanges 22 and 42.

In such a structure, adhesive applied to join the flanges 22 and 42 to each other or molten plastic produced by welding the flanges 22 and 42 to each other is prevented from moving toward the positions located closer to the distal sides of the flanges 22 and 42 than to the joints 25 and 45 by the outer step portions 27 and 47, which serve as obstacles. Thus, the leakage of adhesive or molten plastic toward the outer side of the flanges 22 and 42 through the gaps between the flanges 22 and 42 is limited, and the production of burrs on outer side of the flanges 22 and 42 is limited. This limits situations in which the aesthetic appeal of the intake duct 10 is lowered.

(4) The outer recess 29 is arranged between the joint 25 and the outer step portion 27 on the opposing surface of the flange 22 of the flanges 22 and 42, which are opposed to each other.

In such a structure, when adhesive applied to join the flanges 22 and 42 to each other or molten plastic produced by welding the flanges 22 and 42 to each other is moving toward the positions located closer to the distal sides of the flanges 22 and 42 than to the joints 25 and 45, the adhesive or the molten plastic is accumulated in the outer recess 29. This prevents adhesive or molten plastic from moving toward the distal sides of the flanges 22 and 42 than to the outer recess 29 and further limits the leakage of adhesive or molten plastic to the outer side of the flanges 22 and 42 through the gaps between the flanges 22 and 42.

The above-illustrated embodiment may be modified as follows. The present embodiment and the following modifications can be combined as long as the combined modifications remain technically consistent with each other.

In a first modification shown in FIG. 4, a first flange 122 protrudes outwards from an end of a first wall 121 in the circumferential direction. Further, the middle part of the first flange 122 in the width direction is provided with a protrusion 124 protruding toward a second flange 142. The middle part of the second flange 142 in the width direction is provided with an accommodation recess 144 that accommodates the protrusion 124 of the first flange 122 with gaps spaced apart from each other in the width direction. The end surface of the protrusion 124 and the bottom surface of the accommodation recess 144 are respectively provided with joints 125 and 145 joined to each other.

In this case, the opposing surface of the first flange 122 opposed to the second flange 142 is provided with an inner step portion 126 and an outer step portion 127. The inner step portion 126 is located closer to the proximal side than to the joint 125. The outer step portion 127 is located closer to the distal side than to the joint 125. Further, the opposing surface of the second flange 142 opposed to the first flange 122 is provided with an inner step portion 146 and an outer step portion 147. The inner step portion 146 is located closer to the proximal side than to the joint 145. The outer step portion 147 is located closer to the distal side than to the joint 145.

In the same manner as the second segment, the first segment may be a fibrous molded body. In this case, for example, the following modifications shown in FIGS. 5 to 7 can be employed.

In a second modification shown in FIG. 5, a first flange 222 protrudes outwards from an end of a first wall 221 in the circumferential direction. A protrusion 224 protrudes toward a second flange 242 from the middle part of the first flange 222 in the width direction. The first flange 222 has a shape formed by bending a nonwoven fabric sheet.

The second flange 242 has the same shape as the first modification. The end surface of the protrusion 224 of the first flange 222 and the bottom surface of the accommodation recess 244 of the second flange 242 are respectively provided with joints 225 and 245 joined to each other using adhesive. Further, the protrusion 224 of the first flange 222 is in contact with the accommodation recess 244 of the second flange 242 without any gap.

In this case, the opposing surface of the first flange 222 opposed to the second flange 242 is provided with an inner step portion 226 and an outer step portion 227. The inner step portion 226 is located closer to the proximal side than to the joint 225. The outer step portion 227 is located closer to the distal side than to the joint 225. Further, the opposing surface of the second flange 242 opposed to the first flange 222 is provided with an inner step portion 246 and an outer step portion 247. The inner step portion 246 is located closer to the proximal side than to the joint 245. The outer step portion 247 is located closer to the distal side than to the joint 245.

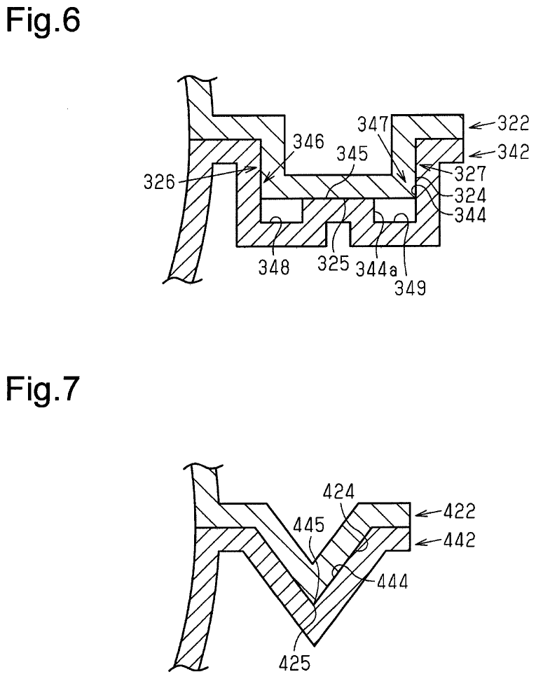

A third modification shown in FIG. 6 differs from the second modification in the following respects. That is, the middle part of an accommodation recess 344 of a second flange 342 in the width direction is provided with a protrusion 344a protruding toward the first flange 322. The end surface of a protrusion 324 of the first flange 322 and the end surface of the protrusion 344a are respectively provided with joints 325 and 345 joined to each other. In this case, an inner recess 348 is provided between the joint 345 and an inner step portion 346. Further, an outer recess 349 is provided between the joint 345 and an outer step portion 347. Such a structure has advantages (2) and (4) of the above-described embodiment.

A fourth modification shown in FIG. 7 differs from the second modification in the following respect. That is, a protrusion 424 of a first flange 422 and an accommodation recess 444 of a second flange 442 have a V-shaped cross section and are in contact with each other. Further, the top of the protrusion 424 and the bottom of the accommodation recess 444 are respectively provided with joints 425 and 445 joined to each other.

The wall of the intake duct may be split by three or more segments.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An intake duct for an internal combustion engine, comprising:
a tubular wall configuring an intake passage, wherein
the wall includes segments that are separate from each other in a circumferential direction of the wall,
at least one of the segments is a compression-molded fibrous body,
each of the segments includes a flange protruding radially outwards from the wall and having a joint, the joint of the flange of each of the segments and the joint of the flange of the corresponding one of the segments being joined to each other, and
each of the flanges includes an opposing surface opposed to the corresponding one of the flanges, the opposing surface being provided with a step portion that is located closer to a proximal side of the flange than to the joint and forms a step in a thickness direction of the flange.

2. The intake duct according to claim 1, wherein a recess is provided between the joint and the step portion on the opposing surface of at least one of the flanges, which are opposed to each other.

3. The intake duct according to claim 1, wherein
the step portion is an inner step portion, and
the opposing surface of each of the flanges is provided with an outer step portion that is located closer to a distal side of the flange than to the joint and forms a step in the thickness direction of the flange.

4. The intake duct according to claim 3, wherein a recess is provided between the joint and the outer step portion on the opposing surface of at least one of the flanges, which are opposed to each other.
